(19) United States
(12) Patent Application Publication
(10) Pub. No.: US 2010/0251259 A1
(43) Pub. Date: Sep. 30, 2010

(54) System And Method For Recruitment And Management Of Processors For High Performance Parallel Processing Using Multiple Distributed Networked Heterogeneous Computing Elements

(76) Inventor: Kevin D. Howard, Tempe, AZ (US)

Correspondence Address: LATHROP & GAGE LLP, 4845 PEARL EAST CIRCLE, SUITE 201, BOULDER, CO, 80301, US

(21) Appl. No.: 12/751,214

(22) Filed: Mar. 31, 2010

Related U.S. Application Data
(60) Provisional application No. 61/165,301, filed on Mar. 31, 2009.
(60) Provisional application No. 61/166,630, filed on Apr. 3, 2009.

(51) Int. Cl. G06F 9/46; G06F 15/16

(52) U.S. Cl. 718/105; 709/204; 718/100

(57) ABSTRACT

A parallel processing computer is described that has several processing devices of several different processing device types each communicating over a computer network. The computer has at least one conversion device in communication with the processing devices, the conversion device being a processing device having conversion code for translating at least some task allocation and other messages from a format understood by the conversion device into a format understood for execution by a particular type of the several types of the processing devices. The computer also has at least one access device in communication with the at least one conversion device, the access device having program code for allocating tasks to processing devices and generating task allocation messages to processing devices. The computer network in an embodiment involves portions of the cellular telephone network as well as part of the internet.

### CROSS-REFERENCE TO RELATED APPLICATIONS

The present application claims priority to U.S. Provisional Application Ser. No. 61/165,301 filed Mar. 31, 2009, and U.S. Provisional Application Ser. No. 61/166,630, filed Apr. 3, 2009, the contents of both of which are hereby incorporated by reference, including their appendices.

### FIELD

The present document relates to an automatic recruitment and management of multiple computing elements for a parallel computing device.

### BACKGROUND

There are large numbers of computing devices available, most of which operate at only a few percent of capacity most of the time. Many of these computing devices are equipped with communication capability such as access to the Internet, access to the digital cellular telephone network, access to local area networks within a business or a military unit, or access to wireless digital networks such as IEEE 802.11g networks that are in turn connected to the Internet. These computing devices, hereinafter sometimes collectively called computing devices, are highly varied, and include laptop and desktop personal computers, personal digital assistants (PDAs), global positioning system (GPS) navigation devices, and even cellular telephones.

Efforts have been made to break certain large computing problems into small portions, then distribute these smaller portions to a large number of these computing devices for execution on what amounts to a synthetic, large, parallel-processor supercomputer that makes use of unused computing capacity on large numbers of personal computers. For example, the Search for Extraterrestrial Intelligence (SETI) at Home (SETI@home) project utilizes central servers to distribute portions of radiotelescope data to participating computers via the internet for analysis, such that analysis of the data portions is performed while the participating computers are otherwise idle. When analysis finishes, the participating computers return findings to the SETI at Home servers.

The SETI at Home system operates by loading a software package on each participating computer that contains internet addresses of the SETI at Home servers. The software package is invoked by a screen saver utility of the participating computer and connects to the SETI@home servers to download a data segment for analysis; the servers track the assignment of the data segments. When analysis is finished, the software package transmits results back to the servers. The servers track return of results and portions for which results are not returned in a reasonable time are re-assigned to other participating computers.

Other applications lend themselves to distributed parallel computing, such as weather prediction and simulations of hot plasmas in proposed fusion reactor designs. Certain military applications may be suitable for distributed computing, including key recovery and decipherment of encrypted messages, and simulation of weapon detonations. In some of these applications, such as weather and plasma simulation, it is desirable to communicate intermediate result information from machines simulating a volume to machines simulating an adjacent volume and to ensure that many portions of the problem, each assigned to a separate processor, progress at about the same rate. In other applications, such as radiotelescope data analysis and brute-force key-extraction from enciphered messages, communications between processors and synchronization of progress of portions of the job is less important.

Other applications for distributed parallel computing may include distributed parallel searching and high volume search and transaction processing applications.

It is desirable to provide improved methods of recruitment and discharge of available processors, improved interprocessor communications within, enhanced reliability of, and otherwise improve on current designs for large, distributed, parallel-processor supercomputers.

### SUMMARY

A heterogeneous parallel processing computer is described as having several processing devices of several different processing device types each communicating over a computer network, a processor bus, radio-frequency network, optical network, or a server bus. The computer has at least one conversion device in communication with the processing devices, the conversion device being a processing device having conversion code for translating at least some task allocation and other messages from a format understood by the conversion device into a format understood for execution by a particular type of the several types of the processing devices. The computer also has at least one access device in communication with the at least one conversion device, the access device having program code for allocating tasks to processing devices and generating task allocation messages to processing devices. The computer network in an embodiment involves portions of the cellular telephone network as well as part of the internet.

### BRIEF DESCRIPTION OF THE DRAWINGS

FIG. 1 is an illustration of a large parallel heterogeneous distributed supercomputer.

FIG. 2 is an illustration of organization of the cellular telephone network.

FIG. 3 is a block diagram showing logical organization of the supercomputer.

FIG. 4 is a flowchart illustrating translations of messages between devices.

FIG. 5 is a flowchart of behavior as emergent processing devices locate the supercomputer, identifies access devices, and establish conversion devices on the supercomputer.

FIG. 6 is a block diagram of an enhanced cellular telephone which may serve as a processing device of the supercomputer.

FIG. 7 is a block diagram of a desktop, laptop, or netbook computer which may serve as a processing device or a conversion-capable device of the supercomputer.

FIG. 8 is an illustration of actions taken by a processing device of the supercomputer when a parent is no longer reachable.

FIG. 9 is a flowchart of automated load balancing on the supercomputer.

### DETAILED DESCRIPTION OF THE EMBODIMENTS

### Supercomputer Overview

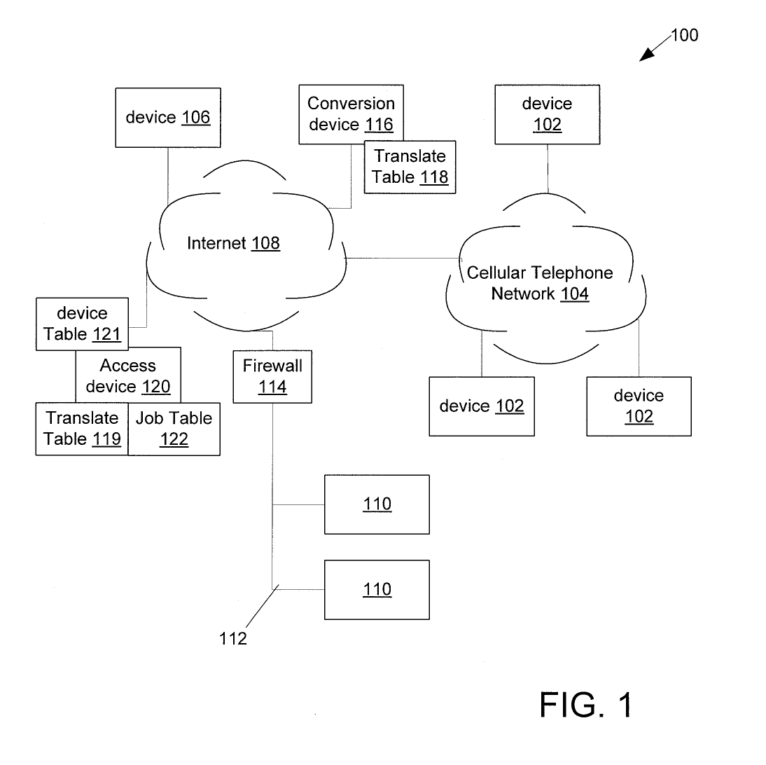

A large, distributed, heterogeneous parallel processing supercomputer 100 is illustrated in FIG. 1. The supercomputer 100 has a large number of processing devices 102, 110, 106, each of which are connected to a network 104, 108.

The network 104, 108 may include the Internet, the wireless cellular telephone network, as well as local corporate and private networks, all of which are interconnected.

The term wireless cellular telephone network includes the (GPRS) General Packet Radio Service for GSM phones, as well as the Cellular Digital Packet Data (CDPD) systems, enhancements such as GSM Evolution (EDGE) (also known as Enhanced GPRS (EGPRS)), High-Speed Downlink Packet Access (HSDPA), and similar systems. These systems include those popularly known as 2^{nd}, 3^{rd}, and 4^{th} generation data-capable wireless digital telephone systems. Devices 102 accessible through the cellular telephone network and which may be utilized as processing devices of the supercomputer 100 are known formally as mobile end stations (M-ES), and informally as digital enhanced cell phones, Blackberries® (trademark of Research In Motion), iPhones, and the like. Devices 102 may include one or more suitably-configured devices capable of performing at least some computing such as personal digital assistants (PDA's), high end cellular telephones, iPhones® (Trademark of Apple, Inc.), Blackberry® (trademark of Research in Motion, inc), units, and other devices. Devices 102 that are accessible through the cellular telephone network may also include laptop computers having wireless interface devices that allow connection to the cellular telephone network.

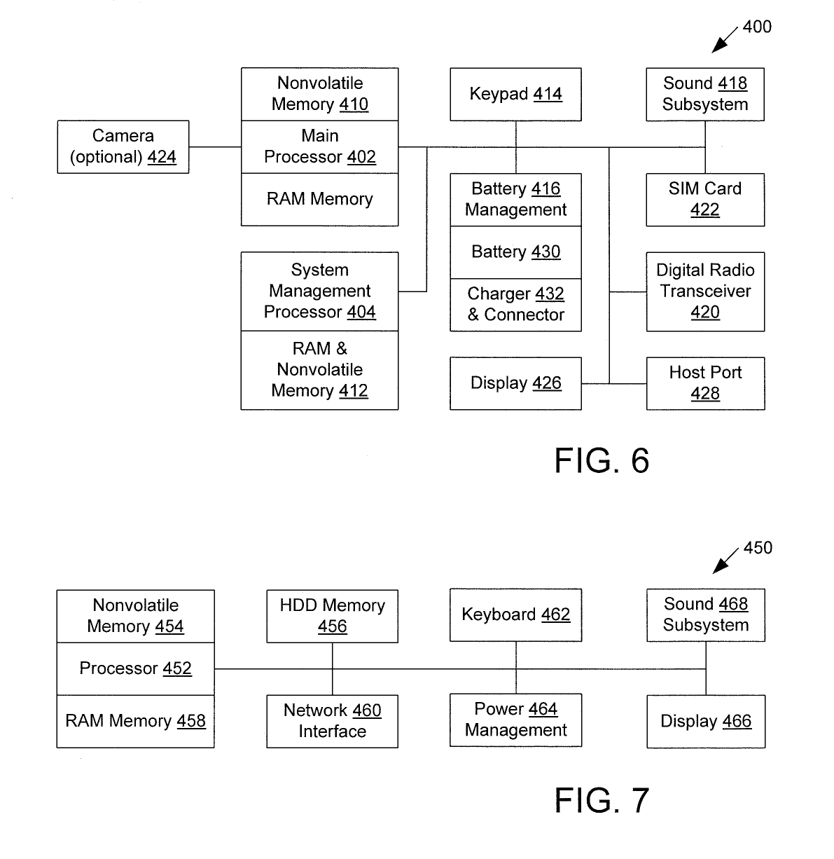

A block diagram of an enhanced cellular phone 400, blackberry, or similar device is illustrated in FIG. 6. Such phones typically have a main processor 402 and a lower-power system management processor 404. Each processor has associated random access memory (RAM), and nonvolatile memory 410, 412. The processors are configured to communicate with one or more keypads 414, a battery management device 416, a sound subsystem 418 including a microphone and speaker together with analog-to-digital and digital-to-analog converters, and a digital radio transceiver 420. Many, but not all, such phones will have a connector for a nonvolatile Subscriber Identity Module (SIM card) 422 and a digital camera 424. Each phone will also have one or more displays 426, and many phones have a host port 428 through which the phone may communicate with a computer. Each phone also has a battery 430, and a battery charger and charger connector 432.

Typically, the main processor 402 is a fairly high performance device capable of performing image compression and decompression, as well as running an operating system and application programs stored in nonvolatile memory 410. The system management processor 404 is a lower performance, lower power consumption, device that is sufficient to operate basic standby telephone functions under direction of firmware stored in nonvolatile memory 412. These standby telephone functions include using the digital radio transceiver 420 to register the phone with the cellular telephone network, using the digital radio transceiver 420 to detect incoming phone calls, and text messages, and monitoring keypad 414 for an attempt to make a phone call or to run a function requiring the main processor 402 be awakened.

Enhanced cellular phones 400 may serve as processing devices 100 of the supercomputer.

Other processing devices 110, including conversion devices 116, and access devices 120, of the supercomputer 100, may be netbook, laptop, or desktop computers 450 as known in the art. These devices 450 typically have at least one, and often more than one, processor 452, a nonvolatile memory 454 typically containing a basic input output system (BIOS) that serves to load an operating system from a hard disk drive 456 into RAM memory 458 for execution. Each processor may also contain multiple processing cores connected through cache to the RAM using one or more PCI, PCIx, or PCIe bus lanes. These devices 450 typically also have a network interface 460, a keyboard 462, a power management subsystem 464, a display system 466, and a sound subsystem 468, as well as many other optional peripherals. Network interface 460 in various embodiments may be a wired 10/100 Base-T Ethernet, may be a wireless network interface such as an 802-11G “Wi-Fi” network, or may be a digital radio compatible with the cellular telephone system. At least one particular type of these devices 116, 120, 450 is designated as a conversion-capable node of the supercomputer because these devices have sufficient RAM memory 458 and HDD memory 456 to store translation tables 118, 119, and may also have room to store device 121 and job 122 tables. In an embodiment, the conversion-capable processing devices are IBM® (trademark of International Business Machines Corp, Armonk, N.Y.)—compatible personal computers, in an alternative embodiment the conversion-capable processing devices are Apple computers.

While the individual computing power of each device, such as device 102, is often small, because there may be many thousands of devices 102, 110, 106 reachable through networks 104 and/or 108, the total computing power of all devices 102 that may be reachable through networks 104 and/or 108 is substantial.

In an embodiment, the supercomputer 100 not only has devices 102 accessed through the cellular telephone network, but also has additional processing devices, such as device 106. These additional processing devices are connected to and reachable through the Internet 108, and network 104 is connected to the Internet 108 in a way that permits digital communication between devices of network 104 and additional processing devices 106. These devices 106 are typically suitably-configured desktop, laptop, and other computer systems such as home and office computers. Many home and office computers have significant unused computing power during most of their operating time.

The supercomputer 100 also has yet more processing devices, such as device 110, that are coupled to business and other local area networks 112, these networks are in turn coupled to the Internet 108 through network firewall devices 114 in a manner that permits at least some digital communication between devices 110 of local area network 112 and Internet 108. Further, the supercomputer 100 may have some devices 106 accessible directly through the internet 108.

Since some devices are of substantially different interconnection method, hardware and operating-system types than others, some devices of the supercomputer 100 are designated as conversion devices 116. Conversion devices are typically processing devices of a particular hardware type that may be among the more powerful processing devices of the supercomputer. In a particular embodiment, conversion devices are high-performance Intel-based personal computers having high-speed 100-BaseT, 1000-BaseT, 10000-BaseT, 20000-BaseT or higher Ethernet (IEEE 802.3), Infiniband or other connections. In the same embodiment, other processing devices may include Intel-based server and personal computers and Apple Mackintosh® computers, as well as Blackberry®, Nokia®, and Palm® handheld devices, having a mixture of high-speed Ethernet connectivity, 802.11G and 802.11N wireless connectivity, cellular network connectivity, local digital radio connectivity, and other connectivity as known in the art. The conversion and processing devices may be distributed over a wide area. For example it is expected that devices of supercomputer 100 may be scattered throughout an entire state, country, or region. In an embodiment, supercomputer 100 may be confined to networks of a specific country to comply with national telecommunications rules and avoid international communications tariffs.

Conversion-capable devices are devices of the same hardware type as conversion devices, but are not currently assigned to serve as conversion devices. These devices are those that can be dynamically reconfigured as conversion devices by loading translation tables 118 and translation software into them, and assigning them to perform translation functions for one or more processing devices.

Conversion devices 116 have translation tables 118 and conversion code that permit them to translate or convert between access methods, protocols, and instruction sets, of one or more non-conversion-capable processing devices and another device, such as an access device, thereby enabling communications with devices of other types. (Access devices are conversion devices having additional capabilities and will be discussed in more detail below.) Conversion devices 116 perform any required translation of address headers and data of messages being relayed from devices of one from one network or device type to devices of another network type or device type, such as between PDAs connected to the wireless cellular network 104 and devices, such as a personal computer device 106, accessible primarily through the internet. They also perform any necessary recompiling of executable programs required for the programs to function on the processing devices.

In an embodiment, application code for processing devices is prepared in a high-level language. A compiler translates this high-level language into an intermediate language that is part of an application program as loaded into an access device when a job is loaded to the supercomputer for processing. The access device distributes the intermediate-level language to the conversion devices. Each conversion device translates the intermediate-level form into a machine-level code suitable for execution on its own hardware and operating system. Each conversion device also translates the intermediate-level form into a machine-level code suitable for execution on the hardware and operating system of each dissimilar processing device in the tree or Howard Cascade of devices accessed through that conversion device. The conversion device then passes those machine-level codes to the appropriate assigned processing devices over the network. In an alternative embodiment, the conversion device passes the intermediate-level form along with the machine-level code to simplify further conversions should any be required before the code reaches final leaf processing devices.

Some conversion devices 116 may connect directly to devices of a specific hardware and software type for which they provide conversion services, others may couple to such devices through existing interconnected networks such as the internet 108, wireless cellular telephone network 104, and local area network 112 to communicate with devices, such as device 102, for which they provide conversion services. Translation tables 118 include mapping tables from addresses in a format suitable for use over a primary communications system, such as internet 108 protocol (IP), to and from addresses for use over a secondary communications system, such as wireless cellular telephone network 104 telephone numbers and cellular provider gateway IP addresses, or local network IP addresses for local networks attached to the internet through a router.

At least one conversion device is designated as an access device 120. The at least one access device typically has translation tables 119, a device table 121, and a job table 122. Job table 122 incorporates information regarding jobs currently running on the supercomputer 100. Device table 121 incorporates lists of identified available conversion devices and processing devices 102, 106, 116, 110, and assignment tables indicating which conversion devices and processing devices 102, 106, 116, 110 are assigned to any one job running on the supercomputer 100.

### Physical Interconnect Speed Variations

During operation of a large distributed heterogeneous parallel supercomputer, such as supercomputer 100 illustrated in FIG. 1, devices, such as devices 102, 106, 116, 110, may communicate with each other. Expected communications include the submission of executable programs and data to devices for processing, exchange of data between devices operating on portions of the same problem, passage of breakpoint-restart information between devices, job control information, and return of results to controlling access devices.

The interconnect of the parallel supercomputer 100 of FIG. 1 has portions that vary in speed from each other. Some devices may be parts of servers physically residing in the same box and communicating with each other by shared memory. Others may connect over network connections of varying speed. For example, local area network 112 may operate for communications between devices 110 of the subnetwork at a significantly higher bandwidth than firewall 114 can communicate to the internet 108. Similarly, firewall 114 may be capable of communicating at a different rate than devices 102 can communicate through the cellular telephone network 104 to devices coupled to the Internet 108, such as devices 116 and 120.

Even within the cellular telephone network 104, communications between some devices 102, or between some devices 102 and the Interned 108, may be faster than others.

In early cellular digital packet data (CDPD) systems, data being sent between devices is sent from an originating device 102 to a cell tower, then through a packet-switched network all the way to a home system associated with the originating device 102. From there, the data is sent to a home system associated with the destination device, and thence back through a packet-switched network to a cell tower associated with the destination device.

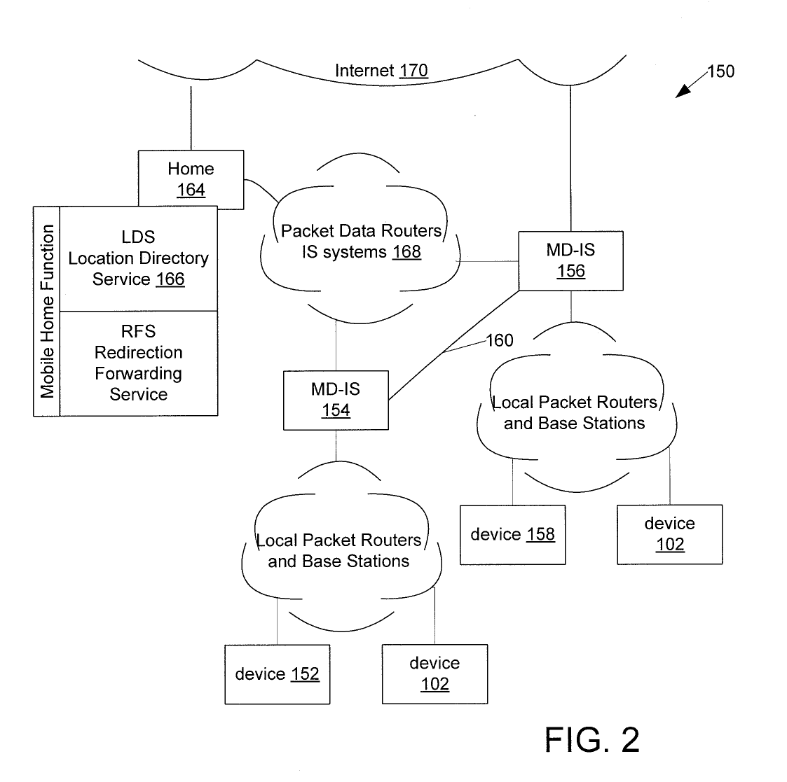

Some newer digital telephone networks 150 operate as illustrated in FIG. 2. In these systems, data packets transmitted by a device 152 are routed to a local Mobile Data Intermediate System (MD-IS). At the local MD-IS 154, the packets are examined to determine their destinations. If a packet is destined for a destination device 158 that is connected to an MD-IS 156 that is physically located near, or the same MD-IS 154, as the originating device is connected to, this sometimes-lengthy path may be bypassed by sending packet data along more direct pathways 160. On these systems, communications between a device 152 and nearby devices 158 may be considerably faster than incoming communications from remote machines that must pass through the home system 164. Similarly, some packets destined for the Internet 170 may also bypass the home system 164.

On these systems, data packets transmitted between a device 152 and remote devices, and to or from many locations, including distant locations, accessible over the Internet 170, may be routed in the traditional manner through home system 164 and transmitted through the cellular packet data network 168 according to location directory and redirection forwarding tables 166 maintained therein.

### Organization of the Distributed Parallel Supercomputer

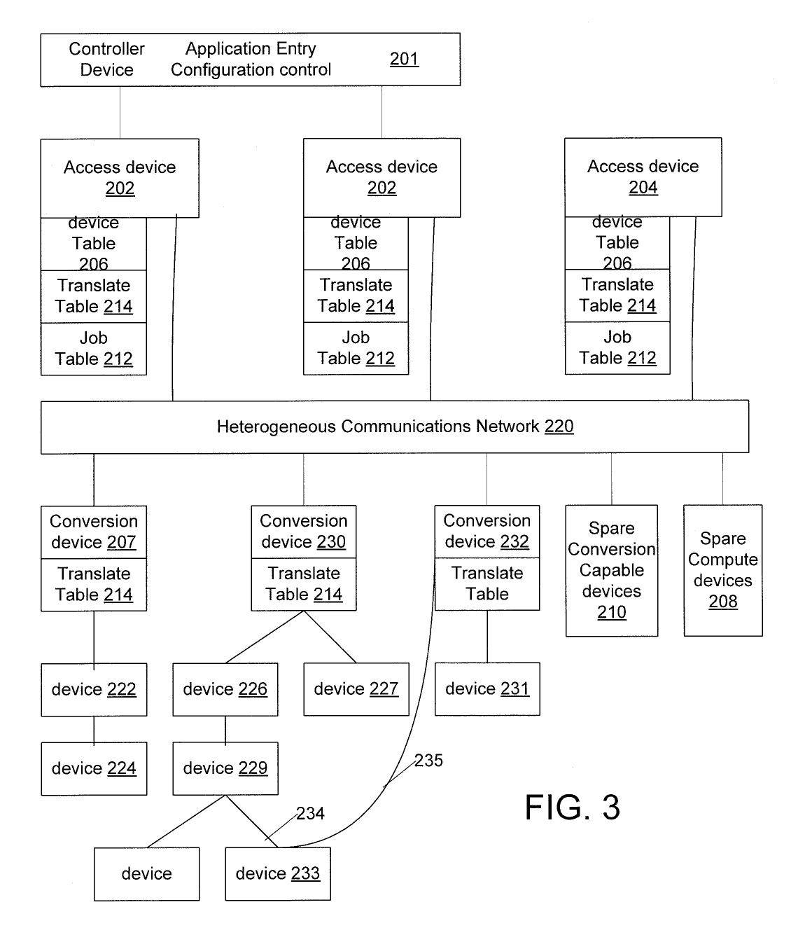

The logical structure of the supercomputer 100 is illustrated in FIG. 3 with reference also to FIG. 1. During operation of a particular job on the supercomputer, each participating device fulfills one or more of the following different roles:

Access device (A) 202, 204, 120,

Translation or Conversion device (T) 207, 230, 232

Compute device (C) 222, 224, 226, 227, 229,

Spare device (S) 208, 210

The Access devices 202, 204 provide for system management and job submission to supercomputer 100 and are high performance devices that serve as Conversion devices. Each Access device 202, 204, maintains a copy of a device table 206 and a job table 212 for the supercomputer 100. It also maintains a master copy of a translation table 214 for supercomputer 100 and operates as an enhanced translation device. Access devices 202 and 204 are the only valid application upload points to supercomputer 100. Updating or adding new jobs or application code to the system requires both an access device and an administration level access code.

The device table 206 contains a list of all devices in the system, with links to current tasks assigned to that device and other device information including an access method associated with that device, performance information regarding the device, and performance information regarding local and global pathways required to access that device. The access method includes any IP-address and/or telephone network number required for data packets to reach that device, identity of any devices and their alternates, such as conversion device 207 that may be required to relay such packets, as well as an instruction language identifier and translation code required to translate code and data for execution on that device. Device table 206 includes information regarding spare processing devices 208 and spare conversion-capable devices 210, and may incorporate lists of which devices are local to each other (i.e., device table 206 may include spatial information of devices of supercomputer 100).

The job table 212 contains information regarding jobs pending, or currently running, on the supercomputer 100. Job table 212 includes a list of devices assigned to each job together with work assignments associated with each nodded; this list includes a map of a tree or Howard Cascade organization of devices associated with the job showing which devices are linked to which. In an embodiment, job table 212 also includes breakpoint restart information received from devices assigned to the job.

The master translation table 214 includes information required for translation of instruction language and communications methods for each type of device expected to be connected to the system.

The communications network 220 of the supercomputer incorporates one or more of the local network 112, Internet 108, and cellular telephone networks 104 of FIG. 1. The network serves to route information between access devices 202, 204, conversion devices 207, spare devices 208, and processing devices 222, 224, 226 of the system. Some processing devices such as compute device 224, may be accessed primarily through another compute device, such as compute device 222. Processing devices 222 may include devices, such as device 102, that connect through the cellular telephone network, office computers such as devices 110 that connect through local networks 112, and other machines, such as device 106, that connect through the Internet 108.

### Adding Jobs to the System

When a system administrator wishes to add an application program or job to the system, he connects a controller device 201 to an access device and authenticates with an administration level access code. The application is then loaded onto the access device 202 and an entry made for it in the job table. When the access device determines that sufficient resources of appropriate kinds exist for the program or job to start, it allocates task work units of the job to appropriate processing devices. Each work unit contains a portion of the job's overall program code, with data on which the code is to run, and may in some cases need to communicate with code in other work units to complete execution. The appropriate processing devices may include processing devices previously listed on the spare compute device list 208 as well as other processing devices capable of multitasking and conversion devices 230 and spare conversion capable devices 210. Once assigned, messages are sent to each assigned device indicating its role in the machine and the work it is expected to perform.

In order to balance performance of the supercomputer, work units of the job are assigned by the access device 202 to devices based upon the performance information regarding that device in the device table 206. Further, device locality is taken into account in order to balance network communication load, work units requiring frequent or high-bandwidth communications with certain other work units are preferentially assigned to devices accessible by high-speed local communications to devices assigned those particular other work units. The access device 202 then updates the job table 212 and device table 206 of other access devices of the supercomputer and distributes the work units to devices of the supercomputer.

The access device 202 takes device locality into account when assigning work units because local communication on similar devices may not require conversion, and thus conversion overhead can be eliminated. Further, as stated above, local communications may allow use of high speed local networks and same-tower cell-network MD-IS bypassing thereby avoiding placing heavy burdens on longer-latency and slower communication paths likely to be encountered between non-local devices.

### Communications Translation

The supercomputer may have devices of widely differing system types. Some devices may run different instruction sets than others, for example some devices may be Intel-based personal computers running under Microsoft® Windows (trademark of Microsoft), other devices may run under Windows CE® (trademark of Microsoft), and other substantially dissimilar operating systems such as Apple MAC-OS® (trademark of Apple Computer, Inc), Linux® or Palm-OS® (trademark of Palm USA), and may have other types of processors. Further, some devices on local subnetworks attached to the internet through routers may be addressed by encapsulating local addresses in packets addressed to the router, and devices connected through the cellular telephone network may be addressed through packets addressed to the Internet IP address of a home system, with an encapsulated telephone number indicating the particular device.

Communications within the supercomputer from processing devices 222, 226 of a first system type to devices of a second system type, or connected through a network of a substantially different type than that coupled to the access device 202, may require translation. This translation may include translation of packet address headers as well as system calls and even breakpoint-restart information and instruction sets for application code. In some cases, little-to-big endian, or vice-versa, conversion may be performed. Since there may be many more processing devices 222, 226, than access devices 202, and some processing devices 222, 226 may have limited storage capability, it is desirable that needed translations be performed prior to receipt of messages at leaf processing devices such as device 224.

Conversion or translation devices 207, 230 each maintain a translation table 214 containing any required routines and methods for translating communications from devices of the first system type to the devices of the second system type, and vice versa. Entries in the translation table 214 associated with a particular translation are referred to herein as an access method for devices of the second system type.

Communications from the one or more access device, typically of the first system type, to devices of the second, or additional, system type are typically routed through conversion devices, such as conversion device 230. When a device needs to pass data to a device of a different system type or to a device on a different network from itself, the destination device's detailed access method must be obtained.

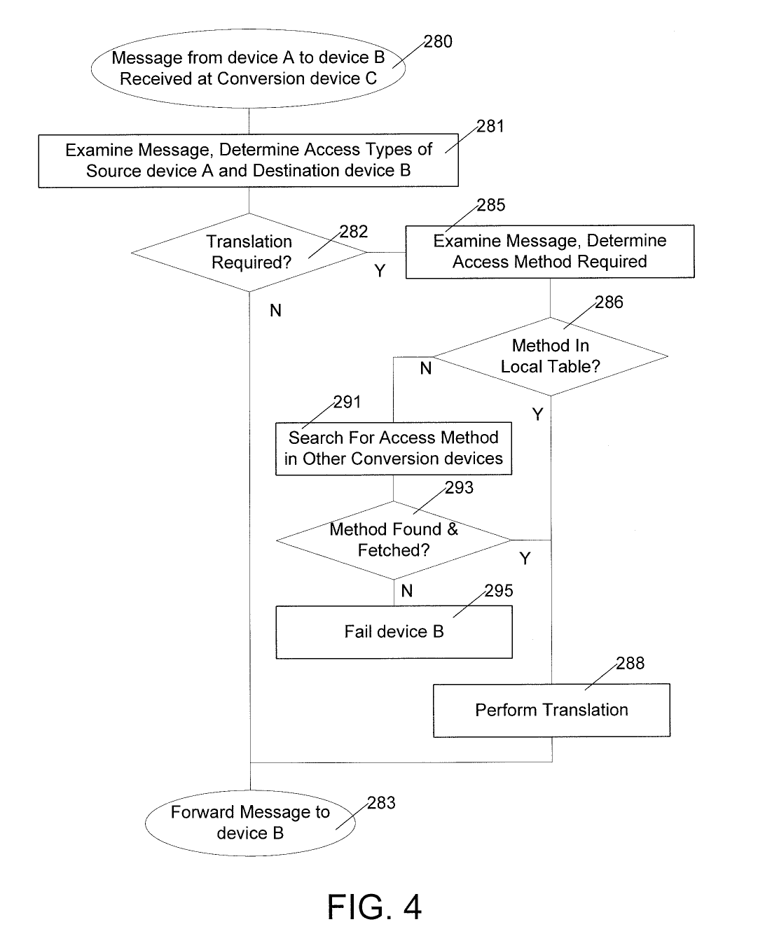

FIG. 4 illustrates operation of a conversion device, such as device 230, of the supercomputer 100 illustrated in FIGS. 1, 2 and 3. Messages received from a device, whether it be a leaf compute device such as device 231, an access device such as device 204, or any other device, that are addressed to a device, such as device 229, accessed through device 230 are received 280 at the conversion device 230. Conversion device 230 examines 281 the messages to determine whether any translation is required, messages not requiring translation are forwarded 283 to their destination device 229. If 282 messages need translation, they are examined 285 to determine what access method is required, and the local translation table 214 is examined to determine 286 if that method is in the table. If the method is available, the message is translated 288 and forwarded 283 to destination device 229.

If 286 the access method is not available, a parallel search 291 for the needed access method is performed by the conversion device 230 of other conversion devices, such as devices 207, 232 including access devices 204, of the system. If 293 the needed access method is found, it is fetched and copied to the local translation table 214, and used to translate 288 and the translated message is forwarded 283. If the needed method can not be found, the destination device 229 is regarded as having failed 295 unexpectedly.

Whenever a device fails unexpectedly, whether because a needed access method can not be found or because the device drops out of the system, work units assigned to that device are restarted on another device, such as device 229. If checkpoint restart information from the device 227 was saved prior to the fault, the work unit is restarted from the checkpoint, otherwise the work units assigned to the device are restarted from their beginnings. The device 227 for which communications could not be adequately translated is placed on a list of devices having communications, and any administrator logged into an access device, such as access device 202, is requested to load the missing access method into an access device of the system. Should the administrator provide the missing access method, that access method is copied to the access devices 202, 204 and conversion devices 207, 230 of the supercomputer, and the device 227 or devices for which communications were not adequately translated are returned to the spare processing devices list 208 for assignment to jobs as needed.

### Addition of Devices to the Supercomputer

During operation of the supercomputer, devices may be added or removed from the supercomputer. This occurs in part because individual machines may be turned on or off, or may be forced into low power modes. For example, a PDA or other enhanced phone may be available for use as a device when connected to a charging device, but may become unavailable when operating solely on battery power because of the high battery drain of many main processors 402 (FIG. 6).

Devices may be added or removed from the supercomputer by command of a system administrator through a controller device 201 linked to an access device 202. The administrator enters identifying information of the new device or devices into the access device 202, the type of the new device is determined, and the new device is linked into the spare conversion-capable devices list 210 or the spare processing devices list 208 as appropriate.

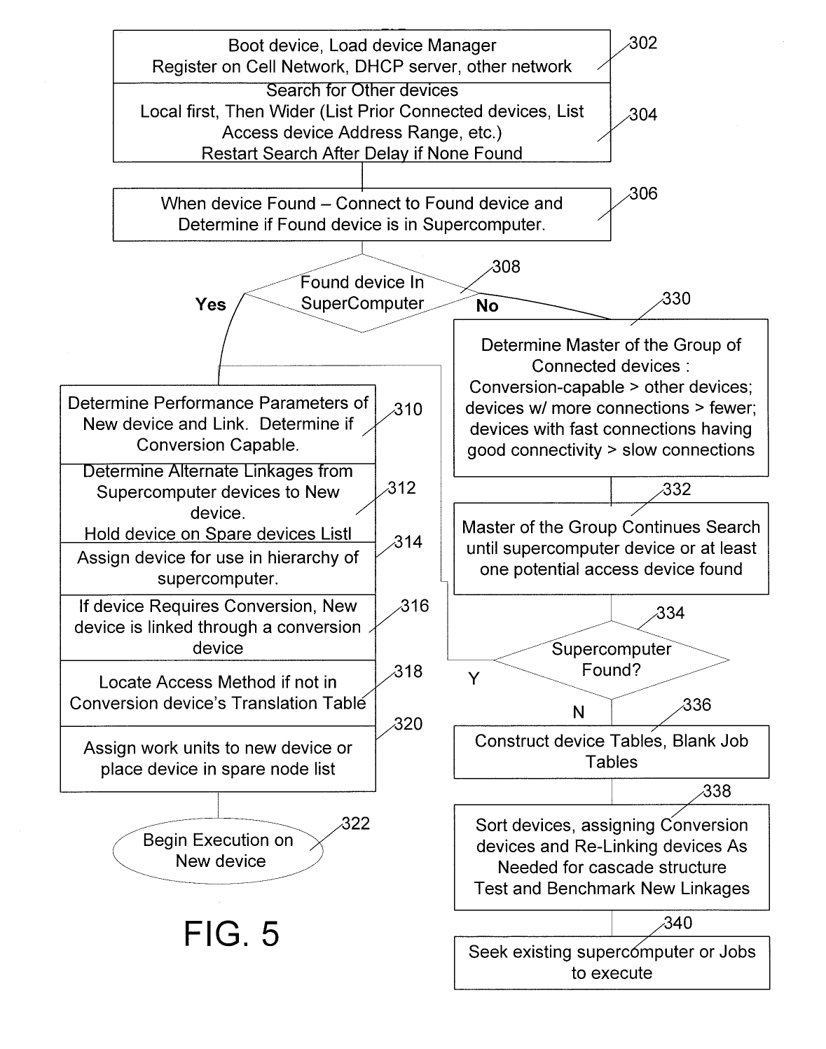

Devices may also be added automatically through emergent behavior of devices. Emergent behavior of devices also permits the supercomputer to self-organize upon startup. FIG. 5 is a flowchart illustrating such emergent behavior.

With reference also to FIGS. 3 and 5, a device, such as device 233, begins during reboot after a crash, during boot following powerup, or when it has become available when a user ceases other compute-intensive usage. The device boots as needed, loads 232 a device manager routine after, and registers itself on any available network. The network on which it registers itself may be a local area network, the Internet, the cell phone network, or another network as known in the art of computing.

Once the device 233 has registered itself on the network, it searches 304 for other devices having device manager routines compatible with the supercomputer. The search may take place using any of several methods dependent on the type of network to which the device is attached, and begins by searching for devices local to device 233, then expands to seek devices more distant from device 233. For example, a device on a local area network searches first for devices on the local area network before expanding its search onto the Internet. The search may incorporate many elements including listening for traffic on a network for network addresses in use, and inquiring of those addresses if they are devices capable of being processing devices of the supercomputer. The search may use a list of network addresses that held devices at prior times or that are a precompiled list of preferred access device addresses. On some networks, the device may broadcast inquiry packets, such as Service Advertising Protocol on Novel networks and listen for responses. On other networks the device may read a device table from a router or switch to obtain addresses to poll, and then polls local addresses first before probing through the router or switch to a higher level of network. When a device is located by the searching device 233, such as device 229, the searching device 233 links to it. Under some circumstances, located device 229 may refuse connection if, for example, the searching device 233 has a history of frequent recent failures, it has a full connection table, or for other reasons.

Once a connection between searching device 233 and located device 229 is established, the devices exchange information and determine 306 if either device is already in the supercomputer. If 308 the searching device is already in the supercomputer, and, if the supercomputer has room for a new device, the searching device becomes a new device 233.

When new devices seek to join the supercomputer, performance parameters of the new device 233 and the link 234 between it and devices, such as device 229, of the supercomputer are determined 310. The new device is also checked to see if it is a conversion-capable device—a device that is capable of becoming a conversion device. The new device may be temporarily linked to a spare devices list 208 or spare conversion-capable devices list 210 until it is needed by the supercomputer. The supercomputer may also establish 312, test, and in some cases abandon, alternative linkages 235 between various other devices, such as conversion device 235 of the supercomputer and the new device 233. The supercomputer may use performance results of testing linkages between devices to classify or group devices according to locality of interconnect between the devices and record this information in device tables 121 for use in allocating work units.

When the new device 233 is needed for use by the supercomputer, an access device or a conversion device of the supercomputer assigns 314 it to parent devices of the hierarchy of the supercomputer. If it requires translations be performed, the parent devices of the hierarchy are assigned 316 to include at least one parent conversion device, that parent conversion device then locates 318 likely needed access modes. Work units are then assigned 320 to the new device, and execution on that device begins 322. Should no work units be immediately available, the device may be assigned to a spare processing device list.

It will often be the case that neither the searching device 233 nor located device 229 are part of the supercomputer when searching device 233 locates located device 229. In this event, the devices 233 and 229 in communication form a Searching Group, devices of the searching group then determine 330 a master of the group. The master is assigned according to a priority list wherein conversion-capable devices rank above devices requiring conversion, and devices having good connectivity, multiple devices linked to them, and fast network connections rank above those with poor connectivity, few linkages, and slow connections. The master of the group then continues to search until a device, such as device 226, that is part of the supercomputer, or a device, such as device 204, that is identifiable as a potential access device is found.

Once a potential access device or a device of the supercomputer is found, devices of the group are passed to the supercomputer, each device being processed 310 as if it were a new device that had located the supercomputer by itself.

If no existing supercomputer was located, but a potential access device 204 is located, the potential access device 204 determines that it is an access device and creates 336 device tables 206 and job tables 212. It then sorts the devices with which it is in communication and organizes the devices with which it is in communication directly or indirectly into a tree or Howard Cascade—a hierarchical structure of interconnected spare devices, conversion devices and processing devices as herein described. The tree or Howard Cascade typically incorporates access devices in a main stem, conversion devices in branches, and processing devices as leaves/. The assigned tree or Howard Cascade structure may, but need not, have processing devices assigned to branches according to locality of interconnect between processing devices, and is described with reference to FIG. 3. With the exception of access devices, each processing device of the tree or Howard Cascade has at least one parent device from which it may receive work units. Processing devices may also be linked to lists of spare and active processing devices. The access device also continues to seek 340 for a supercomputer to join, and merge its own tree or Howard Cascade into, until such time as it receives one or more jobs, or it is instructed otherwise.

Removal of Devices from the Supercomputer

From time to time devices may drop out of the supercomputer. This may happen for many reasons including PDAs or cell phones may lose contact with local towers as they are moved from one location to another, or may be disconnected from an alternating current mains supply and desire to enter a power-conservation mode. Desktop computers and other devices may be turned off, undergo hardware or software failures, or be assigned compute-intensive work such that their participation in the supercomputer can no longer be permitted.

### Automatic Checkpointing, Reassignment, and Restart

Processing devices, such as device 222, having a place in the tree or Howard Cascade are assigned one or more work units by devices, such as device 207, that are higher in the tree or Howard Cascade. Each work unit is either a compact work unit that may be re-run on another device should its assigned device 222 fail to complete it, or a complex, checkpointable, work unit.

Processing devices assigned complex, checkpointable, work units are periodically polled by their parent device in the tree or Howard Cascade to determine if they are still working on their work unit, and checkpoint information, including intermediate results, from those work units is periodically passed to and stored in the parent device. Parent devices may skip polling for a predetermined time after each checkpoint is received.

All processing devices that have failed to return results from a work unit to an assigning parent are polled periodically by their parent to determine if they are still working on the work unit, or if they have lost contact with or withdrawn from the supercomputer.

In the event that a device has lost contact or has restarted, is no longer working on the work unit, and results have been lost, the assigning parent informs its parents of the lost contact, such that they update device tables throughout the supercomputer. The parent device then re-assigns the work unit to another device, known as a replacement device, which may previously be a spare device. Job 122 and device 121 tables are updated appropriately. If the work unit has saved checkpoint information, that information is used to restart the work unit in the replacement device.

Devices desiring to leave the supercomputer may preferably send a loss of availability message to their parent device together with a final checkpoint. Parent devices receiving such messages may treat the leaving device as a failed device immediately; reassigning the work units as appropriate immediately, instead of waiting until polling indicates the leaving device has lost contact. Devices typically send loss of availability messages when they are being shut down, or when enhanced cell phones are disconnected from charging power and desire to enter a low power consumption standby state.

### Groups of Devices Drop to Become Searching Groups

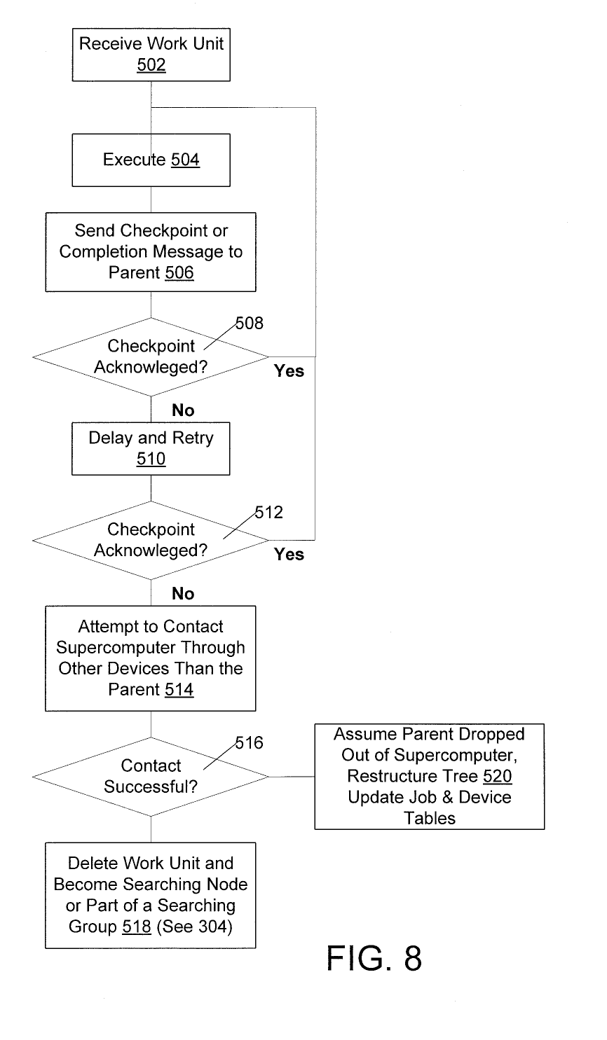

Processing devices of the supercomputer also periodically poll their parent device if they have received no work units. Processing devices that have received work units 502 (FIG. 8) and are executing them 504 periodically send 506 checkpoint information to their parent or return completed work units to their parent; the processing devices expect that each checkpoint or returned work unit be acknowledged 508. Further, processing devices monitor status of their network interfaces for loss of contact with the network whether that is a wired, a wireless, or a cellular telephone network interface.

Should a device find itself out of contact with its parent device through failure to receive acknowledgment of a checkpoint or returned work unit, or out of contact with the network, it retries the connection for a predetermined delay interval 510. Should the checkpoint or returned work unit remain unacknowledged 512, the device attempts to contact the supercomputer through other processing devices of the supercomputer, such as those with it has previously communicated.

If the device contacts the supercomputer through a different device 516, the supercomputer may assume that the parent device has dropped out of the supercomputer and may reassign the device to a different parent in the hierarchy of the tree or Howard Cascade, updating job and device tables accordingly.

In the event that contact is not restored, the device may become a searching device as previously described with regard to emergent behavior of devices joining the supercomputer, see prior discussion with reference to 302 of FIG. 5. Should the device that finds itself out of contact have or remember connections to other devices, it contacts those devices to determine if they are also out of contact with the supercomputer. If a group of devices determines that all of its devices are out of contact with the remainder of the supercomputer, the group of devices that is no longer in contact flushes running processes, selects a master, and becomes a group of devices searching for a supercomputer to join as heretofore described.

### Load Balancing on the Supercomputer

As stated previously, each device has performance characteristics such as processor speed and memory availability, as does each link between devices such as bandwidth and latency, and information regarding these performance characteristics are stored in the device tables 206.

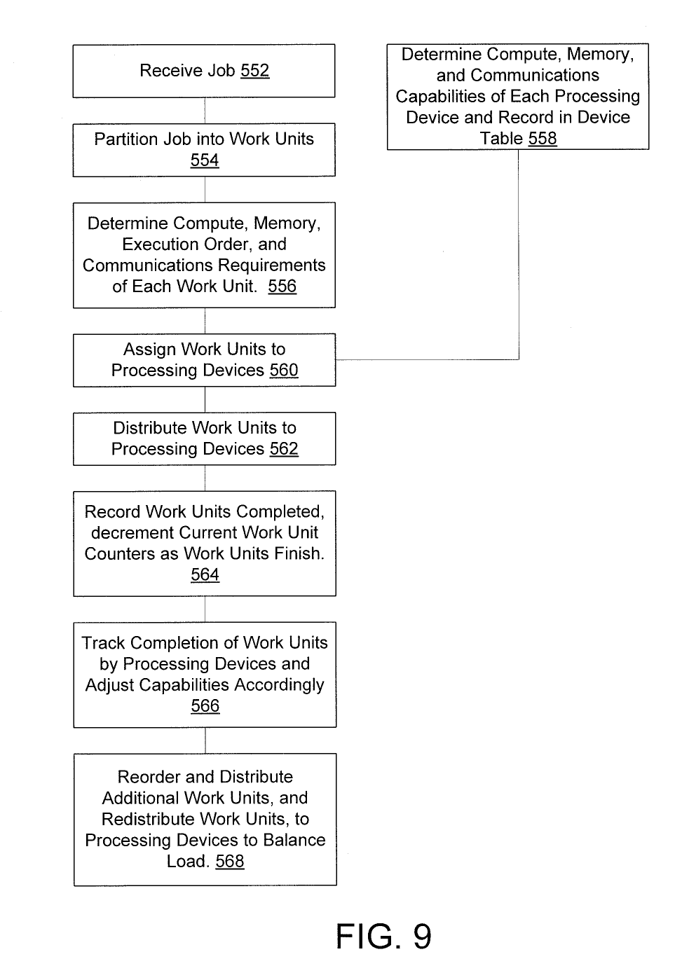

In an embodiment, these performance characteristics are determined 310 (FIG. 5) by running a profiler or benchmarking program as that device joins the supercomputer. In alternative embodiments, performance characteristics are assumed based upon a type of the device as the device joins the supercomputer, and may be updated with performance results as work units are completed. These performance characteristics are stored 558 (FIG. 9) in the device table 121.

In both embodiments, as jobs are received 552 (FIG. 9) by the supercomputer, each job is partitioned 554 into multiple work units. The partitioning into work units is dependent on the type of job. Estimates are determined 556 for each work unit of memory requirements, processing performance requirements, and communications bandwidth requirements with other work units of the job; links are established between work units that must communicate with other work units. Any required order of execution is also determined.

In some jobs, not all work units are created immediately; in these jobs work units are generated by a work-unit generator as the supercomputer can assign them to devices. Further, in some jobs, work units are generated and stored in a pseudo-generator that then provides them to devices of the supercomputer as devices have space to receive them.

Work units are then assigned 560, typically by an access device, to individual processing devices, which may include translation devices, according to their needs for memory, communications, and processing power, and according to the characteristics of available processing devices as recorded in device table 121. Work units requiring high bandwidth communications with other work units are preferably assigned to the same processing device as those other work units, or to processing devices in close network proximity of other devices assigned work units that must communicate with the work unit being assigned. Work units are also assigned based on the order of required execution, the performance required to complete each unit, and performance required of the network links to complete each work unit.

Each processing device is initialized with a maximum work-unit counter, a reorder work-unit counter, a checkpoint period, and the initial work units. The current work-unit counter is set to the initial number of work units. The work units initially assigned 560 to each processing device are distributed 562 through any necessary translation devices to the processing devices, and execution begins.

As work units are completed, each processing device records 564 that fact, decrements its current work-unit counter, and returns results of the completed work units back through the translation devices to the device from which the work units came.

Since the supercomputer is heterogeneous, the assigning devices of the supercomputer track 566 completion of work units to determine whether the processing device characteristics in the device table need adjustment, and whether work units should be reassigned for improved performance. Devices producing results slowly may, for example, have their maximum and reorder work-unit counters decreased and may have some uncompleted work units reassigned to other processing devices. Similarly, devices producing results quickly may have maximum and reorder work-unit counters increased. This automatic adjustment allows the supercomputer to dynamically adapt to such events as when individual processing devices undertake or complete local jobs like video editing, or when communications links like the cellular telephone network or internet are affected by other traffic.

As each work unit completes, the processing device compares its current work-unit counter to the reorder work-unit number, and if the current work-unit count is less than the reorder number then additional work units (enough such that when added to the current work-unit number, the new number is less than or equal to the maximum work-unit counter) are requested from higher processing devices in the tree or Howard Cascade, which may be the assigning device. The assigning devices, or devices higher in the tree or Howard Cascade that have workunits to assign, then assign work units and distribute 568 them to the processing device. The current work-unit counter is increased by the number of work units received by the device.

A computer program product is any machine-readable media, such as an EPROM, ROM, RAM, DRAM, disk memory, or tape, having recorded on it computer readable code that, when read by and executed on a computer, instructs that computer to perform a particular function or sequence of functions. The computer readable code of a program product may be a program, such as a program that when executed on a computer identifies processing devices of a parallel processing supercomputer and offers the computer as a processing device to that supercomputer. A computer system or enhanced cellular telephone having memory, the memory containing code for the program that searches for a parallel processing computer and offers services to that parallel processing computer is therefore also a computer program product.

While the forgoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow.

What is claimed is:

1. A parallel processing computer comprising:
a plurality of processing devices each comprising:
a computer network interface coupled to a processor,
a memory system, and
a power supply for providing power to the network interface, memory system, and processor;
wherein the processing devices are of at least two processing device types;
at least one conversion device in communication with the processing devices, the conversion device comprising a processing device wherein the memory system of the conversion device comprises conversion code for translating at least some task allocation messages from a format understood by the conversion device into a format understood for execution by a particular type of the at least two types of the processing devices and for relaying translated messages to processing devices; and
at least one access device in communication with the at least one conversion device, the access device comprising:
a computer network interface coupled to a processor,
a memory system, and
a power supply for providing power to the network interface, memory system, and processor;
wherein the memory system of the access device comprises program code for allocating tasks to processing devices and generating task allocation messages to processing devices.

2. The parallel processing computer of claim 1 wherein at least two of the processing devices are in communication with each other through a network, the network comprising at least part of the internet.

3. The parallel processing computer of claim 1 wherein at least two of the processing devices are in communication with each other through a network, the network comprising at least part of the cellular telephone network.

4. The parallel processing computer of claim 1 wherein the computer network interface of at least a first processing device is coupled to the cellular telephone network, and the network interface of at least a second processing device is coupled to the Internet, the first and second compute device being in communication with each other.

5. The parallel processing computer of claim 1, wherein the network interface of at least a first processing device is coupled to the cellular telephone network, wherein the first processing device periodically saves checkpoint information on other devices of the supercomputer, wherein the first processing device monitors a charger connection, and wherein the first processing device drops out of the supercomputer upon detecting removal of a charger from the charger connection.

6. The parallel processing computer of claim 1, wherein the conversion device comprises computer readable instructions for translating messages from an access device having a processor using a first instruction set and running a first operating system to a message format intelligible to a processing device having a processor configured to operate under a second instruction set and running a second operating system, the second operating system being substantially dissimilar from the first operating system.

7. The parallel processing computer of claim 1, wherein the conversion code for translating at least some task allocation messages from a format understood by the conversion device into a format understood for execution by a particular type of the at least two types of the processing devices uses a translation table having entries for each type of processing device it can convert to, and further comprises code for searching other conversion devices of the computer for an appropriate translation table entry when it contacts a processing device for which it does not have an appropriate translation table entry.

8. The parallel processing computer of claim 1 further comprising machine readable instructions for dynamically balancing load among processing devices of the computer.

9. The parallel processing computer of claim 8 wherein the instructions for dynamically balancing load and the code for allocating tasks include instructions for:
partitioning a job into work units;
estimating performance of processing devices according to processing device type;
assigning work units to processing devices according to estimated performance of the processing devices; and
tracking completion of work units by processing devices and assigning additional work units to processing devices as work units are completed.

10. The parallel processing computer of claim 9 wherein the instructions for dynamically balancing load and the code for allocating tasks include instructions for:
estimating performance of communication links between processing devices of the supercomputer;
assigning work units to processing nodes according to communications requirements of the work units and estimated performance of communications links.

11. The parallel processing computer of claim 10, wherein the instructions for dynamically balancing load include instructions for adjusting estimated performance of processing devices and communications links according to completion of work units.

12. A computer program product comprising a memory having recorded therein machine readable instructions that when executed on a computing device:
Use a network connection to search for devices capable of being part of a parallel processing supercomputer;
Upon contacting a device, determine whether that device is already part of a parallel processing supercomputer, and if so, instruct the computing device to join the supercomputer as a processing device;
Upon contacting a device that is not already part of a supercomputer, to connect to that device, determine a master of connected devices, and to instruct the master of connected devices to continue searching until devices already part of a supercomputer or capable of becoming access nodes of a supercomputer are found; and
Upon joining a parallel processing supercomputer, accepting and executing work units therefrom.

13. The computer program product of claim 12 further comprising machine readable instructions for translating between computing devices of a first type and computing devices of a second type.

14. The computer program product of claim 13 wherein computing devices of the first type are computers selected from the group consisting of desktop, laptop, and netbook computers, and computing devices of the second type are selected from the group consisting of personal digital assistants (PDAs), and enhanced cellular telephones.
